(19) United States
(12) Patent Application Publication
(10) Pub. No.: US 2015/0113168 A1
(43) Pub. Date: Apr. 23, 2015

(54) Network Bridging

(71) Applicant: Yufei Xu, Beijing (CN)

(72) Inventor: Yufei Xu, Beijing (CN)

(73) Assignee: Hangzhou H3C Technologies Co., Ltd., Hangzhou, Zhejiang (CN)

(21) Appl. No.: 14/402,684

(22) PCT Filed: Aug. 21, 2013
(86) PCT No.: PCT/CN2013/081988

§ 371 Date: Nov. 20, 2014

(30) Foreign Application Priority Data
Sep. 20, 2012 (CN) 201210353162.4

(51) Int. Cl. H04L 29/12

(52) U.S. Cl. CPC H04L 61/2015; H04W 80/04
USPC 709/245

(57) ABSTRACT

A network device is connectable wirelessly to an Access Point AP that is connected to a server. The network device comprises a processing module to receive a Dynamic Host Configuration Protocol (DHCP) message from a client device, to insert in a predetermined option of the DHCP message a Media Access Control (MAC) address of the client device, and to send the DHCP message to the AP to be forwarded to the server for allocation of an IP address to the client device based on the MAC address inserted in the predetermined option of the DHCP message.

### BACKGROUND

In a communication network, a client may communicate on the network using an Internet Protocol (IP) by requesting an IP address from a server of the network. For example, the client may communicate with the server using the Dynamic Host Configuration Protocol (DHCP), whereby the client locates the server in a discovery stage, the server offers an IP address in an offer stage, the client selects the IP address in a request stage, and the server confirms the IP address in an acknowledgement stage. A client may be a piece of software or hardware, for example a computer program, a computer or a terminal. A server may for example be a dedicated computer, a program running on a computer or a router configured to act as a DHCP server.

### BRIEF DESCRIPTION OF THE DRAWINGS

FIG. 1 is a schematic diagram of an example of a Wireless Distribution System (WDS);

FIG. 2 is an example of an IEEE 802.11 3-address format header;

FIG. 3 is an example of a DHCP message;

FIG. 4 is a flow diagram of an example of a method for bridging a sub network to a main network;

FIG. 5 is a flow diagram of an example of a method for allocating an address;

FIG. 6 is a schematic diagram of an example of a network device; and

FIG. 7 is a schematic diagram of an example of a server.

### DETAIL DESCRIPTION

There may be occasions when it is desirable for a local sub-network to access a main network wirelessly. In this case, a network device may access the main network as a wireless client by connecting to an Access Point (AP) of the main network. The network device may then act as a network bridge bridging the sub-network to the main network.

In an example of a method for a wireless network, a network device receives a DHCP message from a client device and inserts in a predetermined option of the DHCP message a MAC (Media Access Control) address of the client device. The DHCP message carrying the MAC address in the predetermined option is sent by the network device to an AP that is connected wirelessly to the network device. The DHCP message is then forwarded to a server for allocation of an IP address to the client device, based on the MAC address in the predetermined option of the DHCP message. According to the example, since the MAC address of the client device is inserted in the predetermined option of the DHCP message, it may be possible for the server to identify the source MAC address of the DHCP message. Thus, the network device may bridge the sub-network to the main network via a wireless connection with the AP. Since the method does not require specially adapted APs, a wide variety of exiting APs may be used and so flexibility is improved.

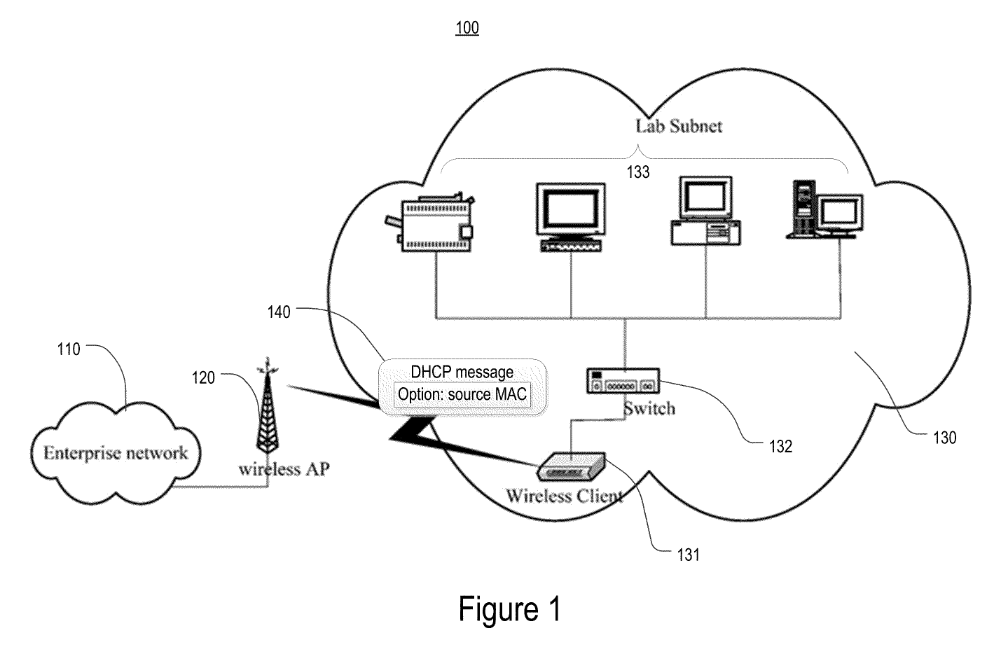

For illustration of the example, a communication system 100 is shown in FIG. 1, a sub-network 130, such as a laboratory subnet, accesses a main enterprise network 110 by connecting a network device 131 as a wireless client to an AP 120 of the enterprise network 110. The network device 131 bridges the subnet 130 to the enterprise network 110 such that client devices 133 may access the enterprise network 110 via the network device 131. According to the example, when the network device 131 receives a DHCP message from one of the client devices 133, it inserts in a predetermined option of the DHCP message the MAC address of the client device. The network device 131 sends the modified DHCP message 140 to the AP 120, which in turn forwards the DHCP message to a server in the enterprise network 110.

In the example, a switch 132 is provided between the network device 131 and the client devices 133 for route switching. However, the switching function may alternatively be incorporated in the network device 131 and the switch 132 may be omitted in this case.

A Wireless Distribution System (WDS) may be implemented using the network device 131 as a wireless bridge, in which case the network device communicates with the AP 120 not only as a client accessing the enterprise network 110 wirelessly, but also acts as a bridge to provide network services through a wired network connecting multiple client devices (or hosts) 133. It should be noted that, although a wired network is used in the example to connect the multiple client devices 133, a wireless network may alternatively be used.

A network device may communicate wirelessly with an AP using an IEEE 802.11 (incorporated herein by reference) message format. When implementing WDS, a WDS-enabled network device typically communicates with an AP using an IEEE 802.11 message format that has four addresses in the message header. In a 4-address 802.11 message header, “Address 1” is the radio MAC of the wireless receiver, “Address 2” is the radio MAC of the wireless transmitter, “Address 3” is the destination MAC address and the additional “Address 4” identifies the source MAC address. However, not all APs are able to support the 4-address 802.11 message header.

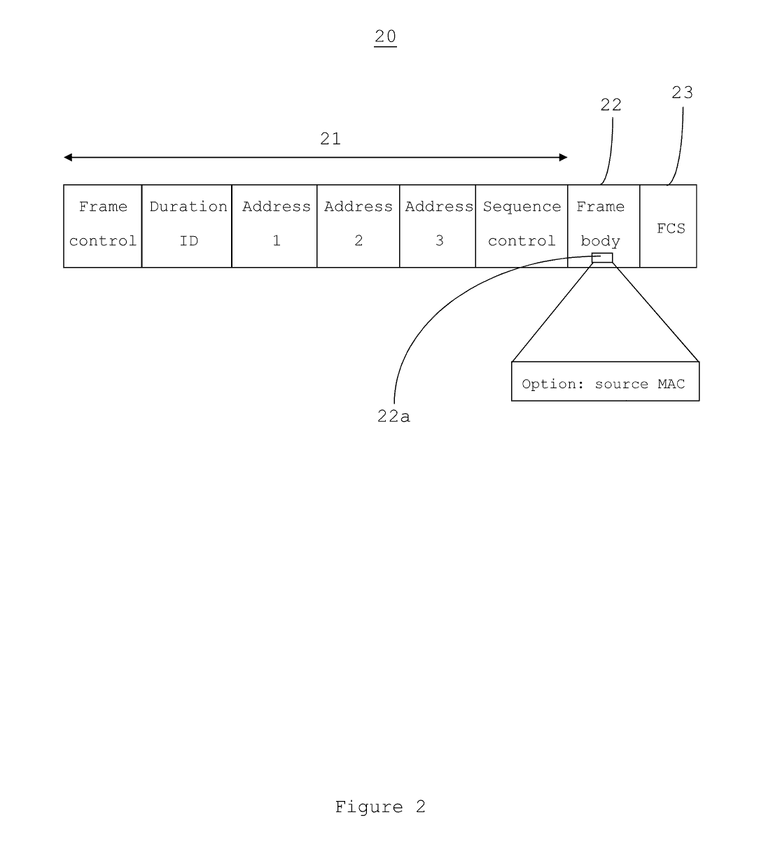

More commonly, a network device communicates with an AP using an IEEE 802.11 message format that has three addresses in the message header, for example as shown in a message 20 in FIG. 2. In the example, the message 20 comprises a header section 21, a frame body 22 and a frame check sequence (FCS) 23. The header section 21 may include a “Frame Control” field, which contains control information that defines the type of 802.11 MAC frame and provides information for processing the MAC frame, a “Duration ID” field, which indicates the remaining duration needed to receive the next frame transmission, three “Address” fields, and a “Sequence Control” field, which includes a sequence number and a fragment number. In the present example of a 3-address 802.11 header, “Address 1” is the MAC address of the wireless receiver, “Address 2” is the radio MAC of the wireless transmitter, and “Address 3” is the destination MAC address. The frame body 22 of the message contains the data of a data-type frame or the information of a management-type frame. In the example, the frame body 22 may include a variable “options” field 22a for optional parameters, for example an indication of the source MAC address. The “options” field is described in more detail below. In the example, the transmitter may use a cyclic redundancy check (CRC) over all the fields of the header 21 and the frame body 22 to generate an FCS value that is included in the FCS field 23. The receiver may then use the same CRC calculation to determine its own value of the FCS field to verify whether or not any errors occurred in the frame during the transmission. It should be noted that different frame formats may be possible within the 802.11 framework, and the methods and devices described herein should not be considered as limited to the specific frame format described above.

In an example of a method for use in a wireless network to bridge a subnet to a main network, a network device receives a DHCP message from a client device of the subnet and inserts in a predetermined option of the DHCP message a MAC address of the client device. The network device then sends the DHCP message to an Access Point AP of the main network, which AP is connected wirelessly to the network device, to be forwarded to a server of the main network for allocation of an IP address to the client device based on the MAC address inserted in the predetermined option of the DHCP message.

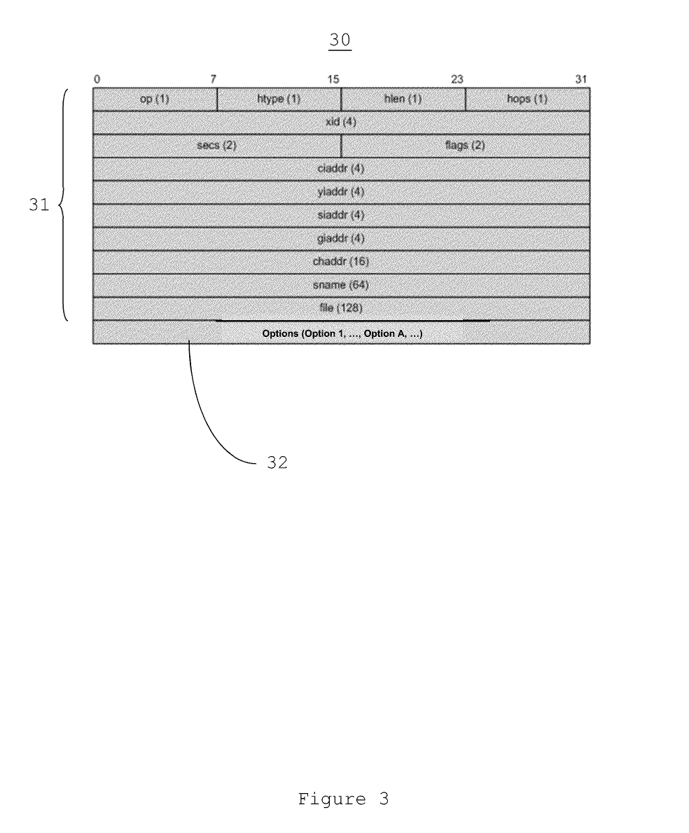

A typical DHCP message format is shown in FIG. 3. A DHCP message 30 comprises a plurality of fields, including, in particular, a “chaddr” field for indicating the hardware address of a DHCP client, and a variable “options” field for including optional parameters that may have variable length. The “options” field may contain up to 255 options, each option is defined by a code, a length, and data. The code is a number from 1 to 255, where, when the code is 1, the option is referred to as “Option 1”. Amongst the 255 options, some are already in use, while some are not used. In the example, the predetermined option may be any option out of the 255 options in the “options” field that is not in use. For convenience of reference, the predetermined option in which the MAC address is inserted is referred to as “Option A” in this disclosure, but it is to be understood that any convenient option of the DHCP message may be used.

According to the example, since the MAC address of the client device is inserted in Option A of the DHCP message, it is possible for the server to identify the source MAC address of the DHCP message. It is therefore possible for the network device to communicate with the AP using a 3-address 802.11 header. Thus, the network device may bridge the subnet to the main network by connecting to the AP even if the AP does not support the 4-address 802.11 message format. The method is thus flexible as it may be used with a wider variety of APs.

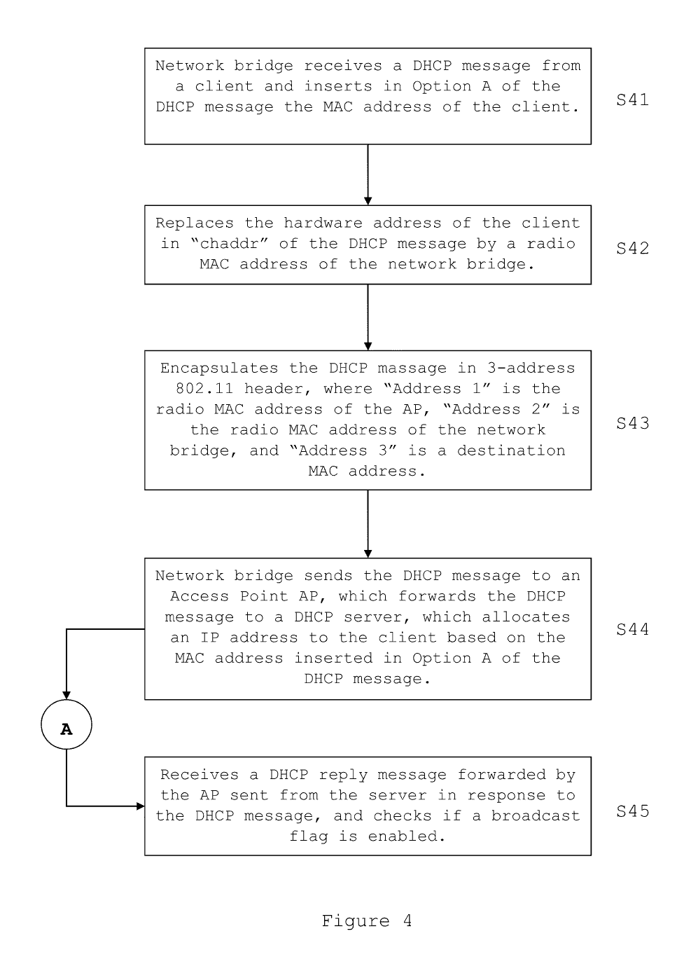

FIG. 4 shows a flow diagram of an example of a method for use in a wireless network to bridge a subnet to a main network. The method may be used in a communication system such as the system 100, in which a subnet is connected to a main network via a network bridge communicating with an AP of the main network.

At block S41, the network bridge receives a DHCP message from a client, for instance one of the client devices 133. The DHCP message may be a DHCP Discover message broadcasted by the client to request an IP address, or it may be a DHCP Request message sent by the client in response to a DHCP Offer. Upon receiving the DHCP message, the network bridge adds a new “options” field in the DHCP message. For example, the network bridge may add a new option using code A with a length of 6 bits. The network bridge inserts the MAC address of the client in the new Option A of the DHCP message.

In an example, the network bridge may replace the hardware address of the client in the “chaddr” field of the DHCP message by the radio MAC address of the network bridge itself at block S42.

For illustration, assume that the MAC address of the client is 1-1-1 and the radio MAC address of the network bridge is 2-2-2.

When the client broadcasts a DHCP Discover message, the source MAC is the client's MAC address 1-1-1, and the “chaddr” field in the DHCP message is the MAC address of the client 1-1-1. When the network bridge receives the DHCP Discover message, it adds a new “options” field in the DHCP message with a code A and a length of 6 bits, and inserts the client's MAC address 1-1-1. In addition, the network bridge replaces the client's MAC address 1-1-1 in the “chaddr” field of the DHCP message by its own radio MAC address 2-2-2.

When the client sends a DHCP Request message, again, the source MAC is the client's MAC address 1-1-1, and the “chaddr” field in the DHCP message is also 1-1-1. When the network bridge receives the DHCP Discover message, it again adds a new “options” field in the DHCP message with a code A and a length of 6 bits, inserts the client's MAC address 1-1-1, and replaces the “chaddr” field of the DHCP message with the MAC address 2-2-2.

By adding the new “options” field Option A in the DHCP message and inserting the client's MAC address in Option A, the DHCP message retains the information of the source MAC.

When the network bridge forwards the DHCP message to a DHCP server in the main network, the source MAC address of the DHCP message becomes that of the network bridge. Thus, by additionally replacing the client's MAC address in the “chaddr” field of the DHCP message by the radio MAC address of the network bridge, when the DCHP server receives the DCHP message, it is possible to perform a security check, such as a DDOS attack check, on the DHCP message by checking if the MAC address in the “chaddr” field matches the source MAC address of the DHCP message.

When the network bridge has completed the modification of the DHCP message received from the client, at block S43, it encapsulates the modified DHCP message in an IEEE 802.11 3-address header, and forwards the encapsulated DHCP message to the AP. In the header, Address 1 is the radio MAC address of the AP, Address 2 is the radio MAC address of the network bridge, and Address 3 is a destination MAC address, for example a broadcast address.

At block S44, the network bridge sends the 802.11-formatted DHCP message to an AP of the main network. In the example, the AP is connected to a DHCP server in the main network via wired Ethernet, thus, upon receiving the 802.11-formatted message from the network bridge, the AP converts the message from the 802.11 format to a 802.3 format, and forwards the 802.3-formatted message to the server.

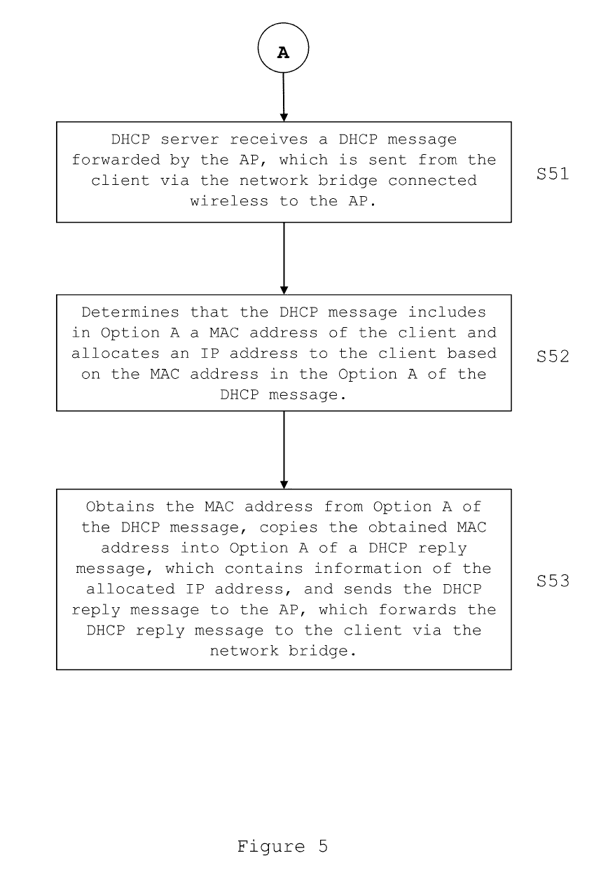

On the server's side, the server allocates an IP address based on the received DHCP message when it receives the 802.3-formatted message. In particular, as shown in FIG. 5, according to an example of a method for allocation of an address, upon receiving the DHCP message forwarded by the AP at block S51, the server determines if the DHCP message includes Option A in the “options” field at block S52. If the DHCP message includes Option A, the server uses Option A as the unique identifier of the client for allocating an IP address.

Then, at block S53, the server obtains the MAC address from Option A of the received DHCP message, and copies the MAC address into a new “options” field of a DHCP reply message. The new “options” field may use the same code A as the DHCP message or a different code may be used. In the example, for convenience, the same code A is used, and so the server copies the obtained MAC address in Option A of the DHCP reply message. The DHCP reply message may be a DHCP Offer message for informing the client of the available IP address (or addresses), or it may be a DHCP Acknowledge message for accepting an IP address request from the client. Thus, the DHCP reply message contains information of the allocated IP address. The server determines from the received DHCP message (DHCP Discover or DHCP Request) if the broadcast flag is enabled. If the broadcast flag is enabled, the server enables the broadcast flag and sets the destination MAC of the DHCP reply message to a broadcast address FFFF-FFFF-FFFF. If the broadcast flag in the DHCP message is disabled, the server sets the destination MAC of the DHCP reply message to the MAC address in the “chaddr” field of the DHCP message, in other words the radio MAC address of the network bridge. The server then sends the DHCP reply message to the AP to be forwarded on.

When the AP receives the DHCP reply message from the server, it converts the 802.3-formatted message into a 3-address 802.11-formatted message. If the DHCP reply message is to be broadcasted, Address 1 is the broadcast address FFFF-FFFF-FFFF; otherwise, Address 1 is the radio MAC address of the network bridge.

Referring back to FIG. 4, when the network bridge receives the DHCP reply message at block S45, it converts the 802.11-formatted message to a 802.3-formatted message with the DHCP server's MAC address as the source MAC address. If the broadcast flag in the DHCP reply message is enabled, the network bridge sets the destination MAC as the broadcast address FFFF-FFFF-FFFF, and broadcast the DHCP reply message in the subnet. If the broadcast flag is disabled, the network bridge uses the MAC address in Option A of the DHCP reply message as the destination MAC, and forwards the message to the client.

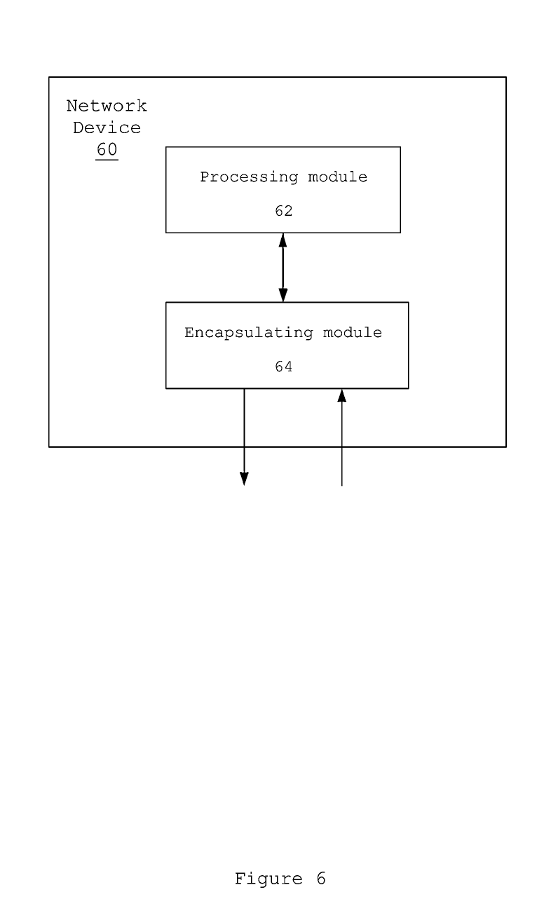

An example of a network device that may perform the function of the network bridge as described in the example method above is shown in FIG. 6. The network device 60 comprises a processing module 62 and an encapsulating module 64.

The processing module 62 is configured to receive a DHCP message from a client device, and to insert a MAC address of the client device in a predetermined option, for instance Option A, of the DHCP message. The processing module 62 is configured to then send the DHCP message to an AP of the main network to be forwarded to a server of the main network for allocation of an IP address to the client device, the allocation being based on the MAC address inserted in Option A of the DHCP message.

In an example, the processing module 62 is further configured to replace a hardware address of the client device in a “chaddr” field of the DHCP message by a radio MAC address of the network device 60.

The encapsulating module 64 is configured to encapsulate the DHCP massage in a 802.11 header having three address fields before sending the DHCP message to the AP. In the 802.11 header, Address 1 is a radio MAC address of the AP, Address 2 is a radio MAC address of the network device, and Address 3 is a destination MAC address.

In the 802.11 header encapsulated DHCP message, the destination MAC address may be a broadcast address.

In an example, the processing module 62 is further configured to receive a DHCP reply message forwarded by the AP, which DHCP reply message is sent from the server in response to the server receiving the DHCP message, and to determine if a broadcast flag is enabled in the DHCP reply message. If the broadcast flag is disabled, the processing module 62 obtains a MAC address from Option A of the received DHCP reply message and forwards the DHCP reply message to the client device using the obtained MAC address.

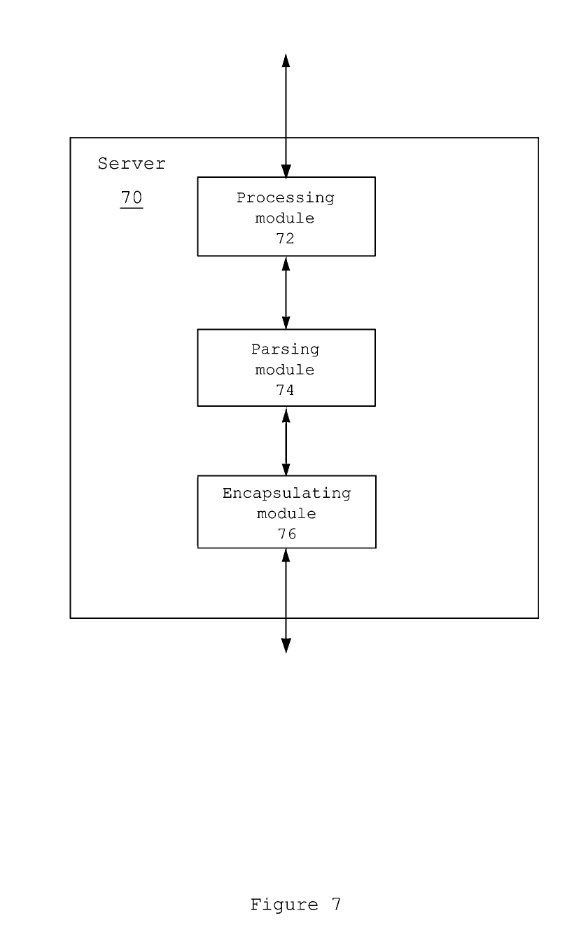

An example of a server that may perform the function of the DHCP server as described in the example method above is shown in FIG. 7. The server 70 comprises a processing module 72, a parsing module 74 and an encapsulating module 76.

The processing module 72 is configured to receive a DHCP message forwarded by the AP that is sent from a client via a network bridge. The processing module 72 then determines whether the received DHCP message includes a MAC address in a predetermined option, for example Option A. If so, the processing module 72 determines that the MAC address in Option A corresponds to the MAC address of the client, and allocates an IP address to the client based on the MAC address in Option A of the received DHCP message. The processing module 72 is further configured to send a DHCP reply message to the AP, which in turn forwards the DHCP reply message to the client via the network bridge. The DHCP reply message may be a DHCP Offer message or a DHCP Acknowledge message, which contains information of the allocated IP address.

The parsing module 74 is configured to obtain the MAC address from Option A of the DHCP message, and using the obtained MAC address to copy it as a new “options” field of the DHCP reply message. The parsing module may copy the obtained MAC address in Option A of the DHCP reply message or a different option code.

In an example, the processing module 72 is further configured to obtain the radio MAC address of the network bridge from the “chaddr” field of the received DHCP message, and determine whether the DHCP reply message is to be broadcasted or unicasted by checking the broadcast flag of the DHCP message.

In an example, the encapsulating module 76 is configured to encapsulate the DHCP reply message in a 802.3 format. If the DHCP reply message is to be broadcasted, the encapsulating module 76 enables the broadcast flag in the DHCP reply message. If the DHCP reply message is to be unicasted, the encapsulating module 76 sets the radio MAC address of the network bridge, obtained in the “chaddr” field of the DHCP message, as the destination MAC address of the DHCP reply message.

Although the flow diagrams described above show a specific order of execution, the order of execution may differ from that which is depicted.

The above examples can be implemented by hardware, software, firmware, or a combination thereof. For example, the various methods and functional modules described herein may be implemented by a processor (the term processor is to be interpreted broadly to include a CPU, processing unit, ASIC, logic unit, or programmable gate array etc.). The methods and functional modules may all be performed by a single processor or divided amongst several processers. The methods and functional modules may be implemented as machine readable instructions executable by one or more processors, hardware logic circuitry of the one or more processors, or a combination thereof. Further, the teachings herein may be implemented in the form of a software product, the computer software product being stored in a storage medium and comprising a plurality of instructions for making a computer device (e.g. a personal computer, a server or a network device such as a router, switch, access point etc.) implement the method recited in the examples of the present disclosure.

It should be understood that embodiments of the method and device described above are implementation examples only, and do not limit the scope of the invention. Numerous other changes, substitutions, variations, alternations and modifications may be ascertained by those skilled in the art, and it is intended that the present disclosure encompass all such changes, substitutions, variations, alterations and modifications as falling within the spirit and scope of the appended claims.

1. A method for use in a wireless network comprising:
a network device receiving a Dynamic Host Configuration Protocol DHCP message from a client device and inserting in a predetermined option of the DHCP message a Media Access Control MAC address of the client device; and
the network device sending the DHCP message to an Access Point AP, connected wirelessly to the network device, to be forwarded to a server for allocation of an IP address to the client device based on the MAC address inserted in the predetermined option of the DHCP message.

2. The method of claim 1 further comprising the network device replacing a hardware address of the client device in a “chaddr” field in the DHCP message by a radio MAC address of the network device.

3. The method of claim 1 further comprising the network device encapsulating the DHCP massage in an IEEE 802.11 header having three address fields before sending the DHCP message to the AP, wherein, in the IEEE 802.11 header “Address 1” is a radio MAC address of the AP, “Address 2” is a radio MAC address of the network device, and “Address 3” is a destination MAC address.

4. The method of claim 3 wherein the destination MAC address is a broadcast address.

5. The method of claim 1 further comprising the network device receiving a DHCP reply message forwarded by the AP sent from the server in response to the DHCP message, determining if a broadcast flag is enabled, if the broadcast flag is disabled, obtaining a MAC address from the predetermined option of the received DHCP reply message and forwarding the DHCP reply message to the client device using the obtained MAC address.

6. A network device for use in a wireless network, the network device being connectable wirelessly to an Access Point AP that is connected to a server, the network device comprising:
a processing module to receive a Dynamic Host Configuration Protocol DHCP message from a client device, to insert in a predetermined option of the DHCP message a Media Access Control MAC address of the client device, and to send the DHCP message to the AP to be forwarded to the server for allocation of an IP address to the client device based on the MAC address inserted in the predetermined option of the DHCP message.

7. The network device of claim 6 wherein the processing module is further to replace a hardware address of the client device in a “chaddr” field in the DHCP message by a radio MAC address of the network device.

8. The network device of claim 6 further comprising an encapsulating module to encapsulate the DHCP massage in an IEEE 802.11 header having three address fields before sending the DHCP message to the AP, wherein, in the IEEE 802.11 header “Address 1” is a radio MAC address of the AP, “Address 2” is a radio MAC address of the network device, and “Address 3” is a destination MAC address.

9. The network device of claim 8 wherein the destination MAC address is a broadcast address.

10. The network device of claim 6 wherein the processing module is further to receive a DHCP reply message forwarded by the AP sent from the server in response to the DHCP message, to determine if a broadcast flag is enabled, if the broadcast flag is disabled, to obtain a MAC address from the predetermined option of the received DHCP reply message and forward the DHCP reply message to the client device using the obtained MAC address.

11. A method for use in a wireless network comprising:
a server receiving a Dynamic Host Configuration Protocol DHCP message forwarded by an Access Point AP, sent from a client device via a network device connected wireless to the AP;
the server determining that the received DHCP message includes in a predetermined option a Media Access Control MAC address corresponding to the client device and allocating an IP address to the client device based on the MAC address in the predetermined option of the DHCP message; and
the server obtaining the MAC address from the predetermined option of the DHCP message, copying the obtained MAC address into the predetermined option of a DHCP reply message containing information of the allocated IP address, and sending the DHCP reply message to the AP to be forwarded to the client device via the network device.

12. The method of claim 11 further comprising the server obtaining a radio MAC address of the network device from a “chaddr” field of the DHCP message, determining whether the DHCP reply message is to be broadcasted or unicasted, and encapsulating the DHCP reply message by enabling a broadcast flag in the DHCP reply message if the DHCP reply message is to be broadcasted, or setting the obtained radio MAC address of the network device as a destination MAC address if the DHCP reply message is to be unicasted.

13. A server, connectable to an Access Point AP that is connected wirelessly to a network device, the server comprising:
a processing module to receive a Dynamic Host Configuration Protocol DHCP message forwarded by the AP from a client device via the network device, to determine that the received DHCP message includes in a predetermined option a Media Access Control MAC address corresponding to the client device, to allocate an IP address to the client device based on the MAC address in the predetermined option of the DHCP message, and to send a DHCP reply message containing information of the allocated IP address to the AP to be forwarded to the client device via the network device; and
a parsing module to obtain the MAC address from the predetermined option of the DHCP message and to copy the obtained MAC address into the predetermined option of the DHCP reply message to be sent by the processing module.

14. The server according to claim 13, wherein the processing module is further to obtain a radio MAC address of the network device from a “chaddr” field of the DHCP message, and to determine whether the DHCP reply message is to be broadcasted or unicasted, the server further comprises an encapsulating module to encapsulate the DHCP reply message by enabling a broadcast flag in the DHCP reply message if the DHCP reply message is to be broadcasted, or to set the obtained radio MAC address of the network device as a destination MAC address if the DHCP reply message is to be unicasted.
